(19) United States
(12) Patent Application Publication
(10) Pub. No.: US 2025/0139652 A1
(43) Pub. Date: May 1, 2025

(54) AIR-VEHICLE MANAGEMENT SYSTEM

(71) Applicant: HONDA MOTOR CO., LTD., Tokyo (JP)

(72) Inventors: Junichiro Kano, Wako-shi (JP); Katsumasa Ishikawa, Wako-shi (JP)

(21) Appl. No.: 18/926,988

(22) Filed: Oct. 25, 2024

(30) Foreign Application Priority Data
Nov. 1, 2023 (JP) 2023-187419

(51) Int. Cl. G06Q 30/0207; G06Q 10/02

(52) U.S. Cl. CPC G06Q 30/0207; G06Q 10/02

(57) ABSTRACT

An air-vehicle management system includes: a candidate air-vehicle extraction portion that extracts a plurality of candidate air-vehicles that are available to perform a reserved flight for a first user; a flight discount information provision portion that transmits first flight discount information to a second user terminal, the first flight discount information providing a notification that a repositioning flight for each candidate air-vehicle of the plurality of candidate air-vehicles is available at a discounted rate; and an air-vehicle-for-use arrangement portion that, when receiving application-for-use information for the repositioning flight and accepting use of the repositioning flight to be performed by a selected air-vehicle, arranges for the selected air-vehicle to perform the repositioning flight and the reserved flight, and stops accepting an application to use the repositioning flight at the discounted rate for any of the plurality of candidate air-vehicles except the selected air-vehicle.

### INCORPORATION BY REFERENCE

The present application claims priority under 35 U.S.C. § 119 to Japanese Patent Application No. 2023-187419 filed on Nov. 1, 2023. The content of the application is incorporated herein by reference in its entirety.

### BACKGROUND OF THE INVENTION

### Field of the Invention

The present invention relates to an air-vehicle management system.

### Description of the Related Art

Conventional systems for accepting reservations for on-demand flights of eVTOLs (Electronic Vertical Take-Off and Landing aircraft) have been proposed (for example, see Japanese Patent Laid-Open No. 2022-034900). The above-mentioned system accepts a reservation for a first flight, and before the departure date and time of the first flight, the system provisionally sets a repositioning flight to relocate a spare eVTOL to the departure location of the first flight. The system also offers a discounted rate for a second flight that arrives at the departure location of the first flight by the departure date and time of the first flight. If a reservation for the second flight is confirmed, the system cancels the provisionally set repositioning flight and updates the flight schedule so that an eVTOL to be used for the second flight is utilized for the first flight as well.

The conventional system described above can enhance the operation efficiency of an eVTOL by utilizing the eVTOL, set to be used for the second flight, for the first flight as well and thereby avoiding relocation of an eVTOL without passengers onboard, if the reservation of the second flight set at the discounted rate is established. If, however, the reservation of the second flight is not established, the system will be required to relocate an empty spare eVTOL to perform the first flight, leading to a disadvantage of not being able to enhance the operation efficiency of the eVTOL.

The present invention has been achieved in view of the background described above and has an object of providing an air-vehicle management system that can arrange an on-demand flight with enhanced operation efficiency of an air-vehicle to be used.

### SUMMARY OF THE INVENTION

An aspect to achieve the object described above provides an air-vehicle management system including: a flight reservation acceptance portion configured to accept a reservation for an on-demand flight by receiving application-for-reservation information for the on-demand flight, the application-for-reservation information being transmitted from a first user terminal used by a first user; a candidate air-vehicle extraction portion configured to, when a reserved flight is accepted by the flight reservation acceptance portion, references an air-vehicle operation database having registered in the air-vehicle operation database operation plans for a plurality of air-vehicles and extracts a plurality of candidate air-vehicles that are available to perform the reserved flight, the reserved flight being to depart from a first departure location at a first departure date and time and to arrive at a first arrival location at a first arrival date and time; a flight discount information provision portion configured to transmit first flight discount information to a second user terminal used by a second user who is not the first user, the first flight discount information providing a notification that a repositioning flight for each candidate air-vehicle of the plurality of candidate air-vehicles is available at a discounted rate, the repositioning flight being to be performed from a parking location of the candidate air-vehicle to the first departure location so as to arrive at the first departure location by the first departure date and time; and an air-vehicle-for-use arrangement portion configured to, when the air-vehicle-for-use arrangement portion receives application-for-use information transmitted from the second user terminal to apply for use of the repositioning flight to be performed by a selected air-vehicle selected from among the plurality of candidate air-vehicles and accepts the use of the repositioning flight to be performed by the selected air-vehicle, arrange for the selected air-vehicle to perform the repositioning flight and the reserved flight, and stop accepting an application to use the repositioning flight at the discounted rate for any of the plurality of candidate air-vehicles except the selected air-vehicle.

In the air-vehicle management system described above, the air-vehicle-for-use arrangement portion may accept an application to use the repositioning flight to be performed by the selected air-vehicle at the discounted rate until the selected air-vehicle is at full occupancy.

In the air-vehicle management system described above, the application-for-reservation information may include information specified by the first user on whether flight sharing with another user is permitted, and when the flight reservation acceptance portion accepts the reserved flight, which is permitted to be shared, the flight discount information provision portion may transmit second flight discount information to a third user terminal used by a third user who is not the first user, the second flight discount information providing a notification that the reserved flight is available at a discounted rate.

In the air-vehicle management system described above, the candidate air-vehicle extraction portion may extract the plurality of candidate air-vehicles by giving priority to an air-vehicle capable of moving both from a parking location to the first departure location and from the first departure location to the first arrival location without replenishment of energy for a power source of the air-vehicle.

In accordance with the air-vehicle management system described above, an on-demand flight can be arranged with enhanced operation efficiency of an air-vehicle.

### BRIEF DESCRIPTION OF THE DRAWINGS

FIG. 1 is a diagram for describing how air-vehicles are managed by an air-vehicle management system;

FIG. 2 is a configuration diagram of the air-vehicle management system;

FIG. 3 is a first flowchart for processing to arrange an air-vehicle to be used for a reserved flight; and

FIG. 4 is a second flowchart for processing to arrange the air-vehicle to be used for the reserved flight.

### DETAILED DESCRIPTION OF THE INVENTION

### 1. How Air-Vehicles are Managed

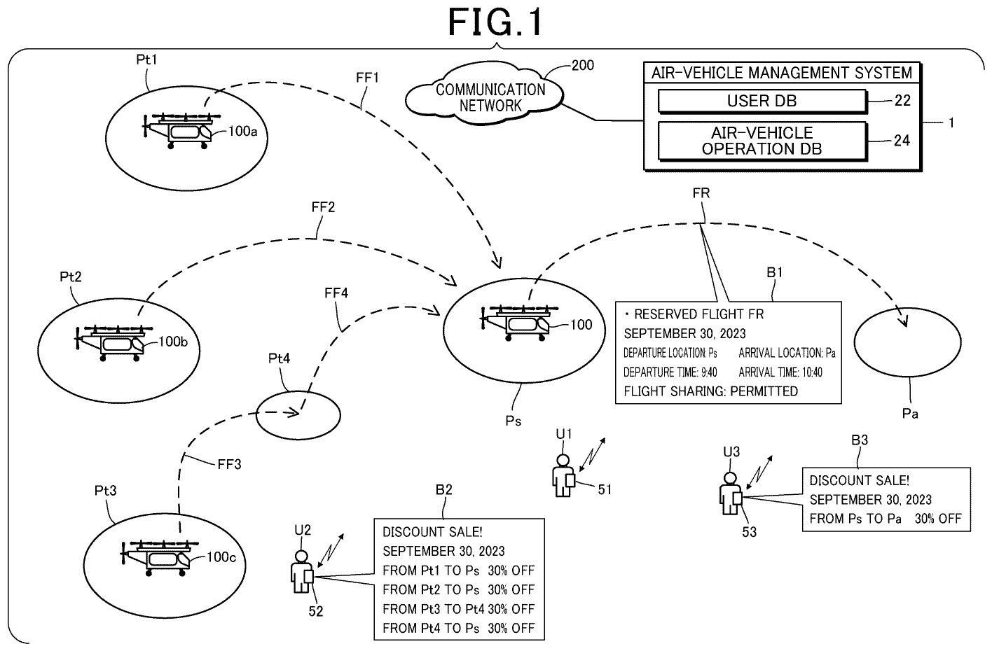

With reference to FIG. 1, how air-vehicles are managed by an air-vehicle management system 1 according to the present embodiment is described. The air-vehicle management system 1 manages operations of a plurality of air-vehicles to be used for flights. An air-vehicle in the present embodiment is an air-vehicle such as a vertical take-off and landing (VTOL) aircraft and can accommodate, for example, about four users.

The air-vehicle management system 1 executes processing to accept applications to reserve flights from a plurality of users registered in a user DB (database) 22 and to arrange air-vehicles to be used for the flights. FIG. 1 exemplifies a first user U1, a second user U2, and a third user U3 as users registered in the user DB 22. The air-vehicle management system 1 communicates via a communication network 200 with a first user terminal 51 used by the first user U1, a second user terminal 52 used by the second user U2, and a third user terminal 53 used by the third user U3.

The first user terminal 51, the second user terminal 52, and the third user terminal 53 are terminal devices having communication functions, such as smart phones, mobile phones, tablet terminals, notebook computers, desktop computers. The first user U1, the second user U2, and the third user U3 apply to reserve flights by accessing the air-vehicle management system 1 using an air-vehicle reservation application (an application program) installed respectively in the first user terminal 51, the second user terminal 52, and the third user terminal 53.

Alternatively, the first user U1, the second user U2, and the third user U3 can access an air-vehicle reservation site provided by the air-vehicle management system 1, in place of the air-vehicle reservation application, and browse a reservation accepting screen to apply to reserve flights. In this case, the first user U1 accesses the air-vehicle reservation site using a web browser installed in the first user terminal 51. Similarly, the second user U2 accesses the air-vehicle reservation site using a web browser installed in the second user terminal 52, and the third user U3 accesses the air-vehicle reservation site using a web browser installed in the third user terminal 53.

FIG. 1 illustrates a situation in which a reserved flight FR has been set in response to an application from the first user U1 to reserve an on-demand flight. The reserved flight FR has conditions below, as shown in a description in B1 in FIG. 1.

Date and time: Sep. 30, 2023

Departure location (first departure location): Ps

Departure time (first departure date and time): 9:40

Arrival location (first arrival location): Pa

Arrival time (first arrival date and time): 10:40

Flight sharing: permitted

“Flight sharing” indicates whether the first user U1 permits sharing of the reserved flight FR with other users. The first user U1 selects whether sharing of the flight is permitted or not at the time of the flight reservation.

The air-vehicle management system 1 includes an air-vehicle operation DB 24 in which operation situations for a plurality of air-vehicles are recorded. The air-vehicle management system 1 references the air-vehicle operation DB 24 and when having extracted air-vehicles that satisfy the reservation conditions specified by the first user U1, the air-vehicle management system 1 accepts the reservation of the on-demand flight for the first user U1.

When the air-vehicle management system 1 extracts a plurality of candidate air-vehicles that satisfy the reservation conditions specified by the first user U1, the air-vehicle management system 1 executes processing to enable passengers to board a repositioning flight for relocating each candidate air-vehicle to the first departure location Ps, which is the departure location of the reserved flight FR, to thereby enhance the operation efficiency of the air-vehicle to be used for the reserved flight FR.

FIG. 1 exemplifies a case in which candidate air-vehicles 100a, 100b, and 100c are extracted as candidate air-vehicles that are available to perform the reserved flight. The following describes the route for the repositioning flight taken when each of the candidate air-vehicles 100a, 100b, and 100c is used for the reserved flight FR.

Candidate air-vehicle 100a: a repositioning flight FF1 from a parking location Pt1 to the first departure location Ps.

Candidate air-vehicle 100b: a repositioning flight FF2 from a parking location Pt2 to the first departure location Ps.

Candidate air-vehicle 100c: a repositioning flight FF3 from a parking location Pt3 to an intermediate location Pt4 and a repositioning flight FF4 from the intermediate location Pt4 to the first departure location Ps.

The air-vehicle management system 1 transmits to a user terminal used by a user who is not the first user U1, information providing a notification that the repositioning flights FF1 to FF4 are offered at discounted rates as shown in a description B2 in FIG. 1. When the air-vehicle management system 1 receives an application to use one repositioning flight of the repositioning flights FF1 to FF4, the air-vehicle management system 1 determines a candidate air-vehicle to be used for the one repositioning flight as a selected air-vehicle 100 to be used for the reserved flight FR.

In this way, the repositioning flight of the air-vehicle to be used for the reserved flight FR can be performed with a user onboard, and thus, the operation efficiency of the air-vehicle can be enhanced over a repositioning flight performed with no user onboard. Additionally, by providing a notification that the repositioning flights FF1 to FF4 to be performed respectively by the candidate air-vehicles 100a to 100c are available at discounted rates, a higher probability is expected that a user who applies for use of a repositioning flight is matched with the repositioning flight.

If “flight sharing permitted” is selected in the reservation conditions for the reserved flight FR, the air-vehicle management system 1 transmits, to a user terminal used by a user who is not the first user U1, information providing a notification that the reserved flight FR is available at a discounted rate as shown in a description B3 in FIG. 1.

Use of the reserved flight FR by a user besides the first user U1 is thus facilitated to increase the seat occupancy of the reserved flight FR, and thereby the operation efficiency of the selected air-vehicle 100 can be enhanced.

### 2. Configuration of Air-Vehicle Management System

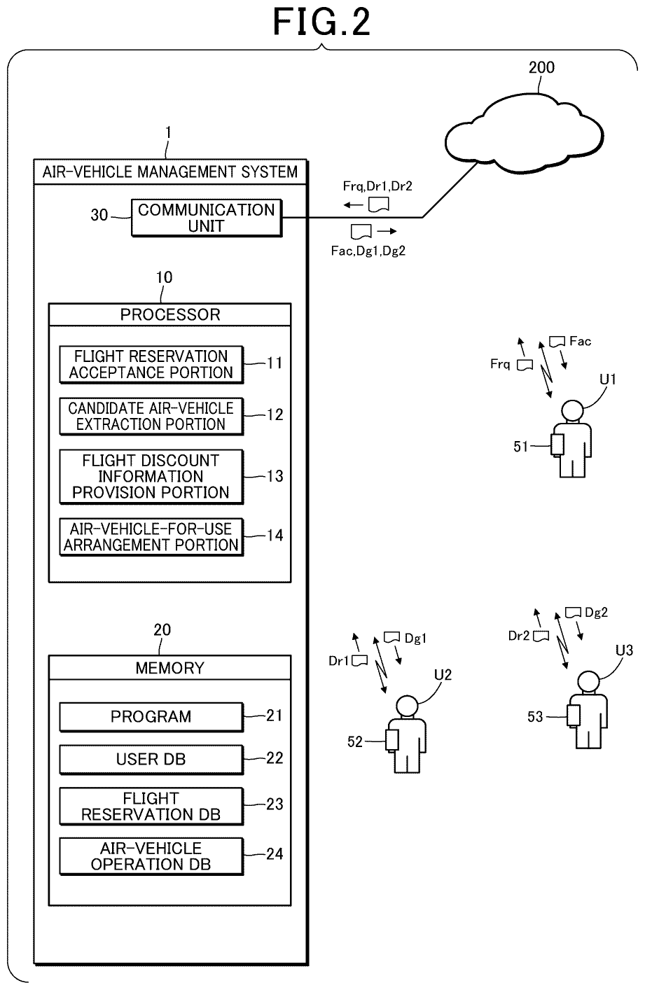

With reference to FIG. 2, a configuration of the air-vehicle management system 1 is described. The air-vehicle management system 1 is a computer system that includes a processor 10, a memory 20, and a communication unit 30. The air-vehicle management system 1 uses the communication unit 30 to communicate via the communication network 200 with the first user terminal 51, the second user terminal 52, and the third user terminal 53, as described above.

The memory 20 has stored therein the user DB 22 and the air-vehicle operation DB 24 described above, as well as a program 21 for controlling the air-vehicle management system 1, and a flight reservation DB 23 in which information on a reserved flight is registered. The processor 10 reads and executes the program 21 to function as a flight reservation acceptance portion 11, a candidate air-vehicle extraction portion 12, a flight discount information provision portion 13, and an air-vehicle-for-use arrangement portion 14.

The flight reservation acceptance portion 11 receives application-for-reservation information Frq for an on-demand flight transmitted from the first user terminal 51 and accepts a reservation of the flight. When the flight reservation acceptance portion 11 accepts the reservation for the flight for the first user U1, the candidate air-vehicle extraction portion 12 references the air-vehicle operation DB 24 and extracts a plurality of candidate air-vehicles available to perform the reserved flight FR. FIG. 1 exemplifies a case in which three candidate air-vehicles 100a, 100b, and 100c are extracted.

The flight discount information provision portion 13 transmits first flight discount information Dg1 to the second user terminal 52 used by the second user U2 who is not the first user U1. The first flight discount information Dg1 provides a notification that the repositioning flights FF1, FF2, FF3, and FF4 are available at discounted rates, where the repositioning flight(s) FF1, FF2, or FF3 and FF4 is needed when the candidate air-vehicles 100a, 100b, or 100c is used for the reserved flight FR.

If “flight sharing permitted” is selected for the reserved flight FR as shown in the description B1 in FIG. 1, the flight discount information provision portion 13 also transmits second flight discount information Dg2 to the third user terminal 53 used by the third user U3 who is not the first user U1. The second flight discount information Dg2 provides a notification that the reserved flight FR is available at a discounted rate.

When the air-vehicle-for-use arrangement portion 14 receives, from the second user terminal 52, application-for-use information Dr1 that applies for use of any of the repositioning flights, the air-vehicle-for-use arrangement portion 14 determines a candidate air-vehicle to be used to perform the repositioning flight specified by the application-for-use information Dr1 as the selected air-vehicle 100 (see FIG. 1) to be used for the reserved flight FR. For example, if the application-for-use information Dr1 applies for use of the repositioning flight FF1 shown in FIG. 1, the air-vehicle-for-use arrangement portion 14 determines the candidate air-vehicle 100a as the selected air-vehicle 100 to be used for the reserved flight FR. In addition, when the air-vehicle-for-use arrangement portion 14 receives application-for-use information Dr2 that applies for use of the reserved flight FR at a discounted rate, the air-vehicle-for-use arrangement portion 14 accepts the application from the third user U3 for the use of the reserved flight FR.

### 3. Air-Vehicle Arrangement Processing

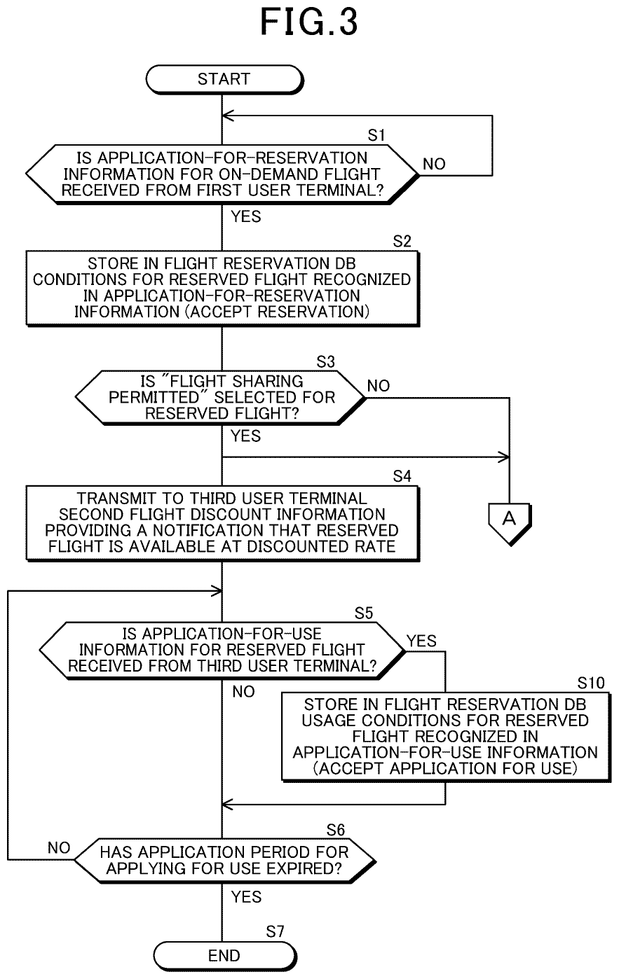

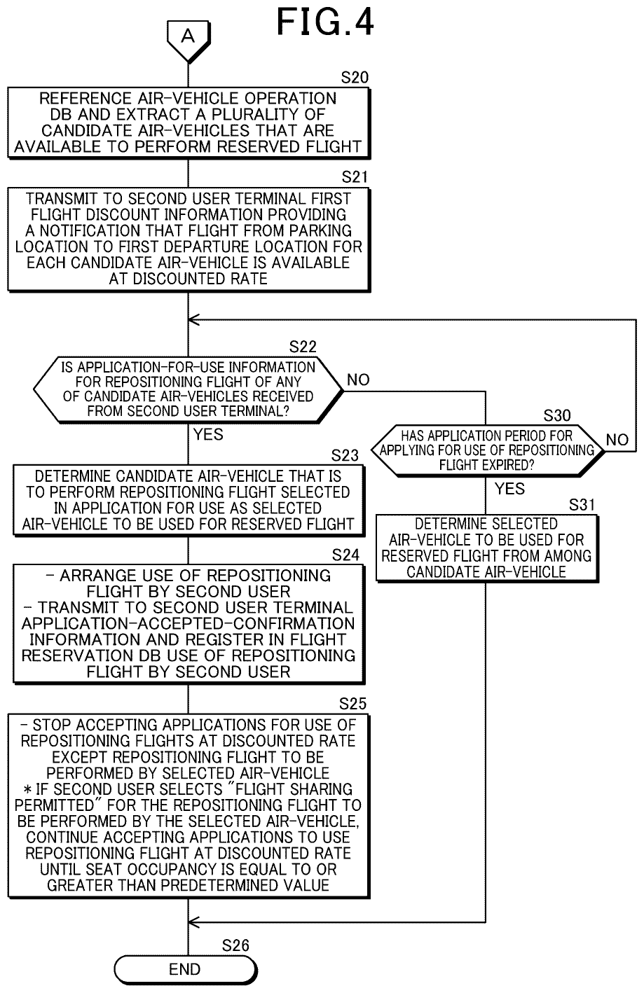

With reference to flowcharts shown in FIGS. 3 and 4, a sequence is described for processing executed by the air-vehicle management system 1 to arrange for an air-vehicle in above-described situation with reference to FIGS. 1 and 2. With reference to FIG. 3, in step S1, if the flight reservation acceptance portion 11 receives the application-for-reservation information Frq for an on-demand flight from the first user terminal 51, the flight reservation acceptance portion 11 proceeds to step S2.

In step S2, the flight reservation acceptance portion 11 registers, with the user DB 22, conditions for a reserved flight FR (see the description B1 in FIG. 1) recognized in the application-for-reservation information Frq and accepts the flight reservation. In subsequent step S3, the flight discount information provision portion 13 determines whether “flight sharing permitted” is specified in the application-for-reservation information Frq (that is, whether the user U1 permits sharing of the reserved flight FR).

If “flight sharing permitted” is not selected, the flight discount information provision portion 13 proceeds to step S20 in FIG. 4. If “flight sharing permitted” is selected, the flight discount information provision portion 13 executes, in parallel, processing of step S4 and beyond and processing of step S20 and beyond in FIG. 4.

Steps S4 to S6 and S10 are processing to accept an application to use flight sharing of the reserved flight FR at a discounted rate. In step S4, the flight discount information provision portion 13 transmits, to the third user terminal 53, the second flight discount information Dg2 (see FIG. 2). The second flight discount information Dg2 provides a notification that the reserved flight FR is available at a discounted rate as shown in the description B3 in FIG. 1.

The third user terminal 53 displays, when having received the second flight discount information Dg2, a screen providing a notification that the reserved flight FR is available at the discounted rate. The third user U3 carries out, when having seen the screen, an operation to apply for use of the reserved flight FR if the third user U3 wishes to use the reserved flight FR. In response to the third user U3's operation to apply for the use, the application-for-use information Dr2 for the reserved flight FR is transmitted from the third user terminal 53 to the air-vehicle management system 1.

In subsequent step S5, the air-vehicle-for-use arrangement portion 14 proceeds to step S10 if the air-vehicle-for-use arrangement portion 14 receives the application-for-use information Frq for the reserved flight FR; the air-vehicle-for-use arrangement portion 14 proceeds to step S6 if the air-vehicle-for-use arrangement portion 14 does not receive the application-for-use information Frq for the reserved flight FR. In step S10, the air-vehicle-for-use arrangement portion 14 stores, in the flight reservation DB 23, usage conditions for the reserved flight FR recognized in the application-for-use information Frq (thereby accepting the application for use) and proceeds to step S6. Additionally, the air-vehicle-for-use arrangement portion 14 transmits, to the third user terminal 53, application-accepted-confirmation information that provides a notification that the application to use the reserved flight FR has been accepted.

In step S6, the air-vehicle-for-use arrangement portion 14 proceeds to step S7 if an application period for applying for use of the reserved flight FR has expired; the air-vehicle-for-use arrangement portion 14 proceeds to step S5 if the application period for applying for use of the reserved flight FR has not expired. The application period for applications to use the reserved flight FR is set to expire, for example, on the date preceding the date when the reserved flight FR is performed.

FIG. 4 shows processing to extract air-vehicles that are available to perform the reserved flight FR and arrange an air-vehicle. With reference to FIG. 4, in step S20, the candidate air-vehicle extraction portion 12 references the air-vehicle operation DB 24 and extracts candidate air-vehicles 100a, 100b, and 100c, which are air-vehicles available to perform the reserved flight FR.

In subsequent step S21, the flight discount information provision portion 13 transmits the first flight discount information Dg1 (see FIG. 2) to the second user terminal 52. The first flight discount information Dg1 provides, as shown in the description B2 in FIG. 1, a notification that the repositioning flight FF1 for the candidate air-vehicle 100a, the repositioning flight FF2 for the candidate air-vehicle 100b, and the repositioning flights FF3 and FF4 for the candidate air-vehicle 100c are available at discounted rates.

The second user terminal 52 displays, when having received the first flight discount information Dg1, a screen providing a notification that the repositioning flights FF1, FF2, FF3, and FF4 are available at discounted rates. The second user U2 considers, when having seen the screen, the use of the repositioning flight FF1, FF2, FF3, and/or FF4. If the second user U2 wishes to use any of the repositioning flights, the second user U2 carries out an operation to apply for use of the desired repositioning flight. In response to the second user U2's operation to apply for the use, the application-for-use information Dr1 for the selected repositioning flight is transmitted from the second user terminal 52 to the air-vehicle management system 1.

The air-vehicle-for-use arrangement portion 14 executes loop processing using steps S22 and S30, and in step S22, when having received the application-for-use information Dr1 from the second user terminal 52, the air-vehicle-for-use arrangement portion 14 proceeds to step S23. If, in step S30, an application period for applying for the use of repositioning flights FF1, FF2, FF3, and FF4 has expired, the air-vehicle-for-use arrangement portion 14 proceeds to step S31. The application period for applying for the use is set to expire, for example, on the date preceding the date when the reserved flight FR is performed.

In step S23, the air-vehicle-for-use arrangement portion 14 determines a candidate air-vehicle that is to perform the repositioning flight selected in the application-for-use information Dr1 as the selected air-vehicle 100 to be used for the reserved flight FR. In subsequent step S24, the air-vehicle-for-use arrangement portion 14 arranges the use of the repositioning flight by the second user U2. The air-vehicle-for-use arrangement portion 14 transmits, to the second user terminal 52, the application-accepted-confirmation information that provides a notification that the application to use the repositioning flight has been accepted. The air-vehicle-for-use arrangement portion 14 also registers, in the flight reservation DB 23, the use of the repositioning flight by the second user U2.

In subsequent step S25, the air-vehicle-for-use arrangement portion 14 stops accepting applications for use of the repositioning flights at the discounted rates except the repositioning flight to be performed by the selected air-vehicle 100. For example, the air-vehicle-for-use arrangement portion 14 stops, when having accepted an application to use the repositioning flight FF1, accepting applications to use the other repositioning flights FF2, FF3, and FF4 at discounted rates. If the second user U2 selects “flight sharing permitted” for the repositioning flight to be performed by the selected air-vehicle 100, the air-vehicle-for-use arrangement portion 14 continues accepting applications to use this repositioning flight at the discounted rate until the seat occupancy of the repositioning flight become equal to or greater than a predetermined value (100%, for example).

If the application period for applying to use the repositioning flights has expired in step S30, the air-vehicle-for-use arrangement portion 14 proceeds to step S31 in which the selected air-vehicle 100 to be used for the reserved flight FR is determined from among the candidate air-vehicles 100a, 100b, and 100c. In this case, the air-vehicle-for-use arrangement portion 14 determines a selected air-vehicle 100 that is more appropriate based on cost, time, and the like required for the repositioning, and proceeds to step S26.

### 4. Anther Embodiments

In the embodiment described above, when the candidate air-vehicle extraction portion 12 extracts a plurality of candidate air-vehicles that are available to perform the reserved flight FR in step S20 in FIG. 4, the candidate air-vehicle extraction portion 12 may extract candidate air-vehicles by giving priority to an air-vehicle that can perform the repositioning flight and the reserved flight FR without replenishment of energy for a power source of the air-vehicle. If the power source is a motor, energy to be replenished is electric power, and if the power source is a combustion engine, energy to be replenished is fossil fuel.

In the embodiment described above, the flight discount information provision portion 13 executes processing to transmit the second flight discount information Dg2 that provides a notification that the reserved flight FR is available at a discounted rate and thereby increase the seat occupancy of the reserved flight FR through sharing of the flight. In another embodiment, the second flight discount information Dg2 may not be transmitted.

In the embodiment described above, a VTOL is used as the air-vehicle in the present disclosure as an example, but the air-vehicle of the present disclosure may be an air-vehicle of another type.

FIG. 2 is a schematic view in which a function configuration of the air-vehicle management system 1 is divided in accordance with the main processing to facilitate understanding of the invention of the present application. The configuration of the air-vehicle management system 1 may be divided in any other way. Further, the processing of each constituent element may be executed by one hardware unit or a plurality of hardware units. Furthermore, processing by each constituent element shown in FIG. 2 may be executed by one program or a plurality of programs.

### 5. Configurations Supported by the Embodiments Described Above

The embodiments described above are specific examples of the following configurations.

(First configuration) An air-vehicle management system including: a flight reservation acceptance portion configured to accept a reservation for an on-demand flight by receiving application-for-reservation information for the on-demand flight, the application-for-reservation information being transmitted from a first user terminal used by a first user; a candidate air-vehicle extraction portion configured to, when a reserved flight is accepted by the flight reservation acceptance portion, references an air-vehicle operation database having registered in the air-vehicle operation database operation plans for a plurality of air-vehicles and extracts a plurality of candidate air-vehicles that are available to perform the reserved flight, the reserved flight being to depart from a first departure location at a first departure date and time and to arrive at a first arrival location at a first arrival date and time; a flight discount information provision portion configured to transmit first flight discount information to a second user terminal used by a second user who is not the first user, the first flight discount information providing a notification that a repositioning flight for each candidate air-vehicle of the plurality of candidate air-vehicles is available at a discounted rate, the repositioning flight being to be performed from a parking location of the candidate air-vehicle to the first departure location so as to arrive at the first departure location by the first departure date and time; and an air-vehicle-for-use arrangement portion configured to, when the air-vehicle-for-use arrangement portion receives application-for-use information transmitted from the second user terminal to apply for use of the repositioning flight to be performed by a selected air-vehicle selected from among the plurality of candidate air-vehicles and accepts the use of the repositioning flight to be performed by the selected air-vehicle, arrange for the selected air-vehicle to perform the repositioning flight and the reserved flight, and stop accepting an application to use the repositioning flight at the discounted rate for any of the plurality of candidate air-vehicles except the selected air-vehicle.

In accordance with the air-vehicle management system of the first configuration, information that provides a notification that a plurality of repositioning flights for a plurality of candidate air-vehicles is available at discounted rates is provided to a second user to determine an air-vehicle to be used for the first user's on-demand reserved flight. The repositioning flight for the air-vehicle to be used for the reserved flight can be thus performed with the second user onboard, and thereby an on-demand flight can be arranged with enhanced operation efficiency of the air-vehicle.

Note that “to transmit first flight discount information to a second user terminal used by a second user who is not the first user” in first configuration includes, in addition to directly transmitting the first flight discount information from the air-vehicle management system to the second user terminal, transmitting the first flight discount information from the air-vehicle management system to the second user terminal via a reservation site, or the like on the web provided by the air-vehicle management system 1.

(Second configuration) The air-vehicle management system according to the first configuration, wherein the air-vehicle-for-use arrangement portion accepts an application to use the repositioning flight to be performed by the selected air-vehicle at the discounted rate until the selected air-vehicle is at full occupancy.

In accordance with the air-vehicle management system of the second configuration, the seat occupancy of the selected air-vehicle to be used for the repositioning flight can be increased, and thereby the operation efficiency of the air-vehicle used for the on-demand flight can be further enhanced.

(Third configuration) The air-vehicle management system according to the first configuration or the second configuration, wherein the application-for-reservation information includes information specified by the first user on whether flight sharing with another user is permitted, and when the flight reservation acceptance portion accepts the reserved flight, which is permitted to be shared, the flight discount information provision portion transmits second flight discount information to a third user terminal used by a third user who is not the first user, the second flight discount information providing a notification that the reserved flight is available at a discounted rate.

In accordance with the air-vehicle management system of the third configuration, sharing of the reserved flight is facilitated, and thereby the operation efficiency of the air-vehicle used for the reserved flight can be enhanced.

Note that “transmits second flight discount information to a third user terminal used by a third user who is not the first user, the second flight discount information providing a notification that the reserved flight is available at a discounted rate” in the third configuration includes, in addition to directly transmitting the second flight discount information from the air-vehicle management system to the third user terminal, transmitting the second flight discount information from the air-vehicle management system to the third user terminal via a reservation site, or the like on the web provided by the air-vehicle management system 1.

(Fourth configuration) The air-vehicle management system according to any one of the first configuration to the third configuration, wherein the candidate air-vehicle extraction portion extracts the plurality of candidate air-vehicles by giving priority to an air-vehicle capable of moving both from a parking location to the first departure location and from the first departure location to the first arrival location without replenishment of energy for a power source of the air-vehicle.

In accordance with the air-vehicle management system of the fourth configuration, time loss associated with the replenishment of the power source (electric power, fuel, and the like) to the air-vehicle can be inhibited, and thereby time required from relocating the air-vehicle to be used for the reserved flight to the completion of the reserved flight can be reduced.

### REFERENCE SIGNS LIST

1 air-vehicle management system
10 processor
11 flight reservation acceptance portion
12 candidate air-vehicle extraction portion
13 flight discount information provision portion
14 air-vehicle-for-use arrangement portion
20 memory
21 program
22 user DB
23 flight reservation DB
24 air-vehicle operation DB
30 communication unit
51 first user terminal
52 second user terminal
53 third user terminal
100 selected air-vehicle
100a, 100b, 100c candidate air-vehicle
200 communication network
U1 first user
U2 second user
U3 third user
FR reserved flight
FF1, FF2, FF3, FF4 repositioning flight
Ps first departure location
Pa first arrival location

What is claimed is:

1. An air-vehicle management system comprising:
a flight reservation acceptance portion configured to accept a reservation for an on-demand flight by receiving application-for-reservation information for the on-demand flight, the application-for-reservation information being transmitted from a first user terminal used by a first user;
a candidate air-vehicle extraction portion configured to, when a reserved flight is accepted by the flight reservation acceptance portion, references an air-vehicle operation database having registered in the air-vehicle operation database operation plans for a plurality of air-vehicles and extracts a plurality of candidate air-vehicles that are available to perform the reserved flight, the reserved flight being to depart from a first departure location at a first departure date and time and to arrive at a first arrival location at a first arrival date and time;
a flight discount information provision portion configured to transmit first flight discount information to a second user terminal used by a second user who is not the first user, the first flight discount information providing a notification that a repositioning flight for each candidate air-vehicle of the plurality of candidate air-vehicles is available at a discounted rate, the repositioning flight being to be performed from a parking location of the candidate air-vehicle to the first departure location so as to arrive at the first departure location by the first departure date and time; and
an air-vehicle-for-use arrangement portion configured to, when the air-vehicle-for-use arrangement portion receives application-for-use information transmitted from the second user terminal to apply for use of the repositioning flight to be performed by a selected air-vehicle selected from among the plurality of candidate air-vehicles and accepts the use of the repositioning flight to be performed by the selected air-vehicle, arrange for the selected air-vehicle to perform the repositioning flight and the reserved flight, and stop accepting an application to use the repositioning flight at the discounted rate for any of the plurality of candidate air-vehicles except the selected air-vehicle.

2. The air-vehicle management system according to claim 1,
wherein the air-vehicle-for-use arrangement portion accepts an application to use the repositioning flight to be performed by the selected air-vehicle at the discounted rate until the selected air-vehicle is at full occupancy.

3. The air-vehicle management system according to claim 1,
wherein the application-for-reservation information includes information specified by the first user on whether flight sharing with another user is permitted, and
when the flight reservation acceptance portion accepts the reserved flight, which is permitted to be shared, the flight discount information provision portion transmits second flight discount information to a third user terminal used by a third user who is not the first user, the second flight discount information providing a notification that the reserved flight is available at a discounted rate.

4. The air-vehicle management system according to claim 1,
wherein the candidate air-vehicle extraction portion extracts the plurality of candidate air-vehicles by giving priority to an air-vehicle capable of moving both from a parking location to the first departure location and from the first departure location to the first arrival location without replenishment of energy for a power source of the air-vehicle.
